(19) United States
(12) Patent Application Publication
(10) Pub. No.: US 2009/0291241 A1
(43) Pub. Date: Nov. 26, 2009

(54) Core for Pavement Marking Tape or Other Highly Aggressive Pressure-Sensitive Adhesive Tape

(75) Inventor: Tony F. Rummage, Hartsville, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sunocodevelopment, Inc.

(21) Appl. No.: 12/124,212

(22) Filed: May 21, 2008

(51) Int. Cl. B32B 1/08

(52) U.S. Cl. 428/34.2

(57) ABSTRACT

A tape core for highly aggressive pressure-sensitive adhesive tape such as pavement marking tape has an outermost ply of a semi-transparent or translucent paper. On the outwardly facing surface of the outermost ply is a coating of release material such as silicone. The core includes directional indicators (e.g., arrows) showing which direction the adhesive tape should be wound about the core. The directional indicators in some embodiments are disposed between the outermost ply and the penultimate ply of the core, in which case the outermost ply is sufficiently translucent that the directional indicators are visible through the ply.

### BACKGROUND OF THE INVENTION

The present application relates to a helically wound paperboard tape core for a pavement marking tape or other highly aggressive pressure-sensitive adhesive tape.

Pavement marking tape is used to provide markings for guiding or warning drivers. The tape is highly reflective to make it visible at night. In order to adhere firmly to pavement, the tape has an extremely aggressive pressure-sensitive adhesive. As a consequence, the tape sticks tenaciously to the core about which the roll of tape is wound. The first turn of tape about the core contacts the paper surface of the core and thus this turn of the tape is not usable because it becomes fouled by paper fibers. Because pavement marking tape is relatively expensive, the cumulative cost of wasting the first turn of tape on each roll of tape produced can be significant.

Furthermore, unwinding the last turn of the highly aggressive tape from the core can also cause the outermost ply of the core to be lifted with the tape, thus delaminating the core.

### BRIEF SUMMARY OF THE DISCLOSURE

The present disclosure is directed to a wound paperboard tape core designed to eliminate this waste of tape by providing a core with a clean-release surface that does not foul the first turn of tape.

A tape core in accordance with one embodiment of the invention has an outermost ply of a semi-transparent or translucent paper. On the outwardly facing surface of the outermost ply is a coating of release material such as silicone. The outwardly facing surface of the penultimate ply of the core (i.e., the ply directly underlying the translucent release-coated ply) is printed with directional indicators (e.g., arrows) showing which direction the tape should be wound about the core. The outermost ply is sufficiently translucent that the directional indicators are visible through the ply. It is important that the highly aggressive tape be wound in the correct direction in order to avoid delaminating the outermost ply from the penultimate ply upon unwinding of the tape.

In another embodiment, the directional indicators are provided on the inwardly facing surface of the outermost ply.

Directional indicators could also be provided (e.g., printed) on the inside surface of the core.

The outermost ply in one embodiment can be a super-calendered bleached kraft paper having a silicone release coating on one side.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a perspective view of a tape core in accordance with one embodiment of the invention; and

FIG. 2 is a diagrammatic view showing a process for making the tape core of FIG. 1.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

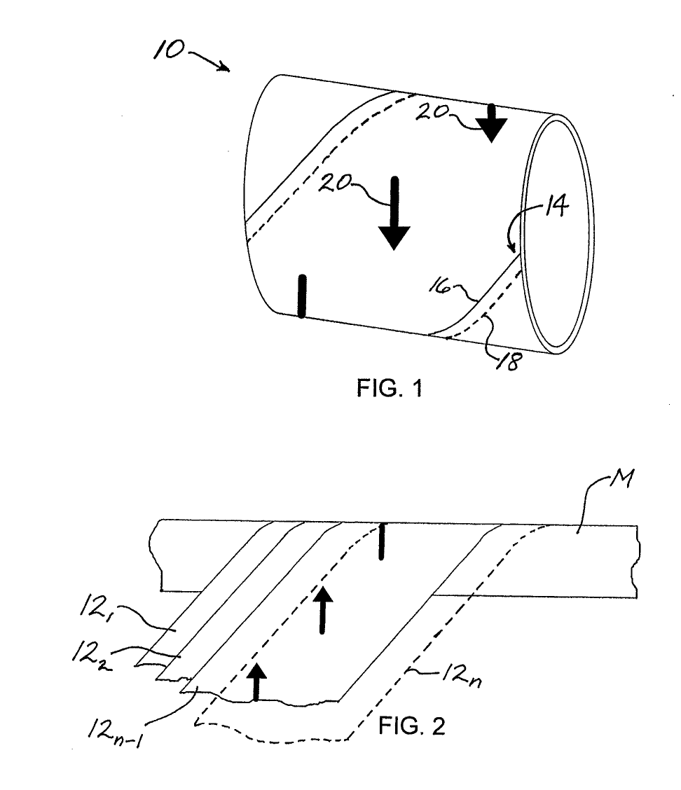

FIG. 1 shows a tape core 10 in accordance with one embodiment of the present invention. A process for making the tape core is diagrammatically depicted in FIG. 2. The tape core is formed as a helically wound tube constructed from a plurality n of paperboard plies 12₁, 12₂, . . . 12ₙ₋₁, 12ₙ, where the radially innermost ply is the ply 12₁ and the radially outermost ply is the ply 12ₙ. The tube is constructed by helically wrapping the plies one upon another about a cylindrical mandrel M and adhering them together with a suitable adhesive applied to the plies prior to wrapping them about the mandrel. The tape core is shown in FIG. 2 as being constructed from four plies in total, but it will be understood that the tape core can be formed with any suitable number of plies depending on the needs of a particular application.

Conventionally, tape cores formed as helically wound paperboard tubes have an outermost paperboard ply that presents a bare paperboard surface on which the adhesive tape is wound. As noted, this leads to the problem of the last turn of tape lifting paper fibers from the paperboard surface so that it loses the desired tackiness and cannot be used. Additionally, the tape can also delaminate the outermost ply from the tube. This occurs mainly when the tape is not wound in the “proper” direction about the tape core. More particularly, with reference to FIG. 1, it will be seen that the outermost ply 12ₙ presents an acute-angled “dog ear” 14 at one end of the tape core because of the helical direction in which the ply is wound. In the illustrated embodiment, a trailing edge 16 of the outermost ply overlaps a leading edge 18 of the previous turn of the ply. Alternatively, there could be a butt joint or a slight gap between the edges 16, 18, but in any event the dog ear 14 is always present. When the tape is wound about the core in the same general direction that the acute angle of the dog ear points, the tape can lift the dog ear as the last turn of tape is unwound. This can cause part or all of the outermost ply to be delaminated from the underlying penultimate ply 12ₙ₋₁.

To address these problems existing in prior tape cores, the tape core 10 in accordance with the present invention includes directional indicators 20 that indicate the proper direction to wind the adhesive tape about the core. The directional indicators can be, for example, arrows as shown. Preferably, there are a plurality of the directional indicators 20 spaced about the circumference of the core with a small enough circumferential spacing that in any rotational orientation of the core at least one of the directional indicators 20 is visible. It will be appreciated from FIG. 1 that when the adhesive tape is wound about the tape core 10 in the direction indicated by the directional indicators 20, the dog ear 14 will not be lifted when the tape is unwound.

In accordance with one embodiment of the invention as illustrated in FIG. 2, the directional indicators 20 comprise ink or the like (e.g., paint, or other pigment-containing medium) printed onto the radially outwardly facing surface of the penultimate ply 12ₙ₋₁. Alternatively, the indicators can be printed on the radially inwardly facing surface of the outermost ply 12ₙ.

The outermost ply 12ₙ is shown in dashed lines in FIG. 2 to signify that the ply is translucent—i.e., the outermost ply has a sufficient visible light transmissivity to allow the directional indicators 20 to be seen by a human observer located adjacent the radially outwardly facing surface of the outermost ply. It will be appreciated that the degree of visibility of the directional indicators 20 depends on a number of factors including the transmissivity of the outermost ply, the degree of color contrast between the indicators 20 and the color of the outermost ply, and the color intensity of the indicators. Advantageously, the color indicators should be a color that has a large color contrast relative to the outermost ply. Suitable colors can include, for example, black, dark blue, dark brown, bright red, and the like.

The outermost paperboard ply 12ₙ, as noted, is translucent. Typical paperboard plies for use in tape cores or the like have very small visible light transmissivity and would not be suitable for use in the present tape cores. Additionally, as noted, the outermost ply advantageously should be coated on its radially outer side with a release material such as silicone or the like. In accordance with the invention, a special paperboard material is employed for the outermost ply. As one example, the outermost ply can be a super-calendered bleached kraft paper that is silicone-coated on one side, and having a basis weight of about 42 lb/ream and a caliper of about 0.003 inch (0.076 mm). A suitable commercially available bleached silicone-coated kraft paper of this type is Grade 40703 available from Loparex. However, any suitable paper having sufficient visible light transmissivity to allow viewing of the directional indicators through the paper can be used. Advantageously, the outermost ply should have an opacity of about 60 to about 64 as measured by standard test procedure TAPPI T425 or ISO/DIS 2471. It will be understood that opacity is the converse of light transmissivity, such that a high opacity corresponds to a low transmissivity and a low opacity corresponds to a high transmissivity.

Alternatively, tape cores in accordance with the invention can employ an outermost ply 12ₙ of non-paper material such as polymer film.

The tape core 10 can have various dimensions depending on the needs of a particular application. Typical tape cores have an inside diameter ranging from about 1 inches to about 6-inches, with approximately 3 inches being a commonly used size. The length of the core corresponds to the width of the adhesive tape. Typically pavement marking tape is 4 inches wide. The wall thickness of the core can range from about 0.045 inch to about 0.350 inch. As one example, a tape core in accordance with the invention can have an inside diameter of 3.015 inches, a length of 4 inches, and a wall thickness of 0.110 inch.

Many modifications and other embodiments of the inventions set forth herein will come to mind to one skilled in the art to which these inventions pertain having the benefit of the teachings presented in the foregoing descriptions and the associated drawings. For example, the directional indicators 20 can be printed on the radially outwardly facing surface of the outermost ply 12ₙ before the release coating is applied. In this case, the release coating has a sufficiently high transmissivity to visible light that the directional indicators are visible through the release coating. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A tape core for highly aggressive pressure-sensitive adhesive tape, comprising:
a plurality of paperboard plies helically wrapped one upon another about an axis and adhered together to form a tubular tape core, the paperboard plies including an outermost ply and a penultimate ply radially inward of and contiguous with the outermost ply, the outermost ply having a radially outwardly facing surface and an opposite radially inwardly facing surface;
a coating of a release material disposed on the radially outwardly facing surface of the outermost ply to form a surface from which the pressure-sensitive adhesive tape will readily release; and
one or more visible directional indicators disposed between the outermost ply and the penultimate ply for indicating a correct winding direction in which the pressure-sensitive adhesive tape should be wound onto the tape core;
the outermost ply having a sufficient transmissivity to visible light that the directional indicator(s) can be seen through the outermost ply.

2. The tape core of claim 1, wherein the outermost ply comprises a bleached kraft paper.

3. The tape core of claim 1, wherein the release material comprises a silicone.

4. The tape core of claim 1, wherein the one or more directional indicators comprise ink printed onto a surface of one of the penultimate and outermost plies.

5. The tape core of claim 4, wherein the one or more directional indicators are printed onto a radially outwardly facing surface of the penultimate ply.

6. The tape core of claim 4, wherein the one or more directional indicators are printed onto the radially inwardly facing surface of the outermost ply.

7. The tape core of claim 1, wherein the one or more directional indicators indicate that the winding direction for the pressure-sensitive adhesive tape is in generally the same direction in which the outermost ply is helically wrapped.

8. The tape core of claim 1, wherein the tape core has a length of approximately 4 inches and an inside diameter of approximately 3 inches.

9. The tape core of claim 8, wherein the tape core has a wall thickness of approximately 0.1 inch.

10. A tape core for highly aggressive pressure-sensitive adhesive tape, comprising:
a plurality of paperboard plies helically wrapped one upon another about an axis and adhered together to form a tubular tape core, the paperboard plies including an outermost ply having a radially outwardly facing surface and an opposite radially inwardly facing surface;
a coating of a release material disposed on the radially outwardly facing surface of the outermost ply to form a surface from which the pressure-sensitive adhesive tape will readily release; and
one or more visible directional indicators disposed between the radially outwardly facing surface of the outermost ply and the coating of release material;
the coating of release material having a sufficient transmissivity to visible light that the directional indicator(s) can be seen through the coating of release material.
